(19) United States
(12) Patent Application Publication
(10) Pub. No.: US 2026/0316787 A1
(43) Pub. Date: Oct. 15, 2026

(54) AUTONOMOUS TRACTOR SAFETY MECHANISMS AND METHODS

(71) Applicant: Outrider Technologies, Inc., Henderson, CO (US)

(72) Inventors: Alec Likhite, Arlington, MA (US); Vasa Subramaniam, Arnhem (NL); Suyash Kumar, Eindhoven (NL); Ryan Arata, Littleton, CO (US); Ralf Siebert, Hoevelaken (NL); Samuel Mitchell, Arvada, CO (US); Gonzalo Victorio-Cuellar, Rochester, MI (US)

(21) Appl. No.: 19/461,442

(22) Filed: Jan. 27, 2026

Related U.S. Application Data
(60) Provisional application No. 63/750,191, filed on Jan. 27, 2025.

(51) Int. Cl. B60W 60/00; B60W 30/08; H04W 4/44

(52) U.S. Cl. CPC B60W 60/0015; B60W 30/08; B60W 60/005; H04W 4/44; B60W 2030/082; B60W 2300/145; B60W 2420/403; B60W 2420/408; B60W 2520/10; B60W 2520/22; B60W 2530/205; B60W 2555/60; B60W 2556/45

(57) ABSTRACT

An autonomous tractor operating within an autonomous yard implements safety mechanisms that validate apriori safety critical data and process multi-sensor operational data to generate trusted data. When a safety violation is detected, an emergency stop (E-STOP) is triggered to place the tractor in a safe state where actuators are disabled. These mechanisms ensure safe operation by preventing unintended movement and mitigating hazards in environments with other vehicles and personnel.

### RELATED APPLICATION

This application claims priority to US Patent Application Serial No. 63/750,191, titled “Autonomous Tractor Safety Mechanisms and Methods,” filed Jan. 27, 2025, which is incorporated herein by reference in its entirety.

### BACKGROUND

An autonomous tractor operates within an autonomous yard to move trailers between parking spots, unloading spots, and loading spots. Other vehicles and personnel may also operate within the autonomous yard and accordingly, safety is a concern.

### SUMMARY

One aspect of the present embodiments includes the realization that safety is of paramount importance for an autonomous tractor operating within a yard where other vehicles and personnel are present. The present embodiments solve this problem by using a safety mechanism to monitor operation data of the tractor to ensure that it conforms to safety requirements.

Another aspect of the present embodiments includes the realization that a safety mechanism requires trusted data. Where operational data of an autonomous tractor operating within a yard is conflicting, invalid, or is corrupted, the data cannot be trusted for determining safety of the tractor. The present embodiments solve this problem by processing the operational data through an safety enabler that determines whether or not the operational data is trusted. For example, the safety enabler compares operational data from multiple sources and determines that the operational data is trusted when the differences are within a predefined tolerance. The safety enabler may also validate apriori safety critical data that defines one or both of a site data and vehicle parameters when received from an external source to prevent operation of the tractor with invalid or corrupt data. These features improve functional safety compliance (e.g., ISO 26262), reduce collision risk, and enable high-integrity autonomous operation in mixed-traffic environments.

In certain embodiments, the techniques described herein relate to a system for implementing safety within an autonomous tractor operating in an autonomous yard, including: a controller including at least one processor and memory storing machine-readable instructions; a plurality of sensors including a camera, a LIDAR, a radar, and an optical encoder; a plurality of actuators including a trailer connect actuator, a fifth wheel actuator, a steering actuator, and a brake actuator; safety interlocks configured to default to a safe state when unpowered; wherein the machine-readable instructions, when executed by the processor, cause the processor to: (a) validate apriori safety critical data including site data and vehicle parameters by authenticating a digital signature and verifying a checksum of a manifest file; (b) process operational data from the sensors to generate trusted data; (c) validate trailer information including trailer presence, length, width, bogey distance, and angle using the camera, the LIDAR, the radar, and the optical encoder; (d) monitor dock light status via wireless communication and verify communication integrity; (e) enforce speed limits and stop conditions at junctions and crosswalks based on occlusion detection; (f) pre-clear a parking spot or loading dock using sensor data and prevent the tractor or trailer from entering a non-cleared space; (g) detect a safety violation based on the trusted data; and (h) initiate an emergency stop (E-STOP) to place the tractor in the safe state where actuators are disabled.

In certain embodiments, the techniques described herein relate to a method for implementing safety within an autonomous tractor operating in an autonomous yard, including: (a) validating apriori safety critical data including site data and vehicle parameters by authenticating a digital signature and verifying a checksum of a manifest file; (b) processing operational data from a camera, a LIDAR, a radar, and an optical encoder to generate trusted data; (c) validating trailer information including trailer presence, length, width, bogey distance, and angle using the operational data; (d) monitoring dock light status via wireless communication and verifying communication integrity; (e) enforcing speed limits and stop conditions at junctions and crosswalks based on occlusion detection; (f) pre-clearing a parking spot or loading dock using sensor data and preventing the tractor or trailer from entering a non-cleared space; (g) detecting a safety violation based on the trusted data; and (h) initiating an emergency stop (E-STOP) to place the tractor in a safe state where actuators are disabled.

In certain embodiments, the techniques described herein relate to a method for implementing safety in an autonomous tractor operating within an autonomous yard, including: receiving operational data from a plurality of sensors of the tractor; validating apriori safety critical data including site data and vehicle parameters prior to autonomous operation; generating trusted operational data by comparing the operational data from multiple sources to ensure integrity; processing the trusted operational data through a plurality of safety mechanisms to detect a safety violation; and initiating an emergency stop (E-STOP) to bring the tractor to a safe state when the safety violation is detected.

In certain embodiments, the techniques described herein relate to a system for implementing safety in an autonomous tractor operating within an autonomous yard, including: a controller including: an autonomy monitor module configured to validate apriori safety critical data and monitor operational data for safety violations; a performance processing module configured to control autonomous movement of the tractor; a plurality of sensors including a location unit, cameras, LIDAR, radar, and an optical encoder; and safety interlocks configured to inhibit actuation of one or more components of the tractor; wherein the autonomy monitor module triggers an E-STOP to place the tractor in a safe state when a safety violation is detected.

### BRIEF DESCRIPTION OF THE FIGURES

FIG. 1 is an aerial view showing one example autonomous yard that uses an autonomous tractor to move trailers between a staging area and loading docks of a warehouse, in embodiments.

FIG. 2 is a block diagram illustrating example functional components of the tractor of FIG. 1, in embodiments.

FIG. 3 is a schematic illustrating the autonomy monitor module of FIG. 2 in further example detail, in embodiments.

FIG. 4 is a schematic illustrating the autonomy processing module of FIG. 2 in further example detail, in embodiments.

FIG. 5 is a schematic illustrating the vehicle monitor of FIG. 2 in further example detail, in embodiments.

### DETAILED DESCRIPTION OF THE EMBODIMENTS

In an automated yard, an autonomous tractor moves trailers between staging areas and loading docks for unloading and/or loading. The autonomous tractor repeatedly couples (hitches) to a trailer, moves the trailer, and then decouples (unhitches) from the trailer.

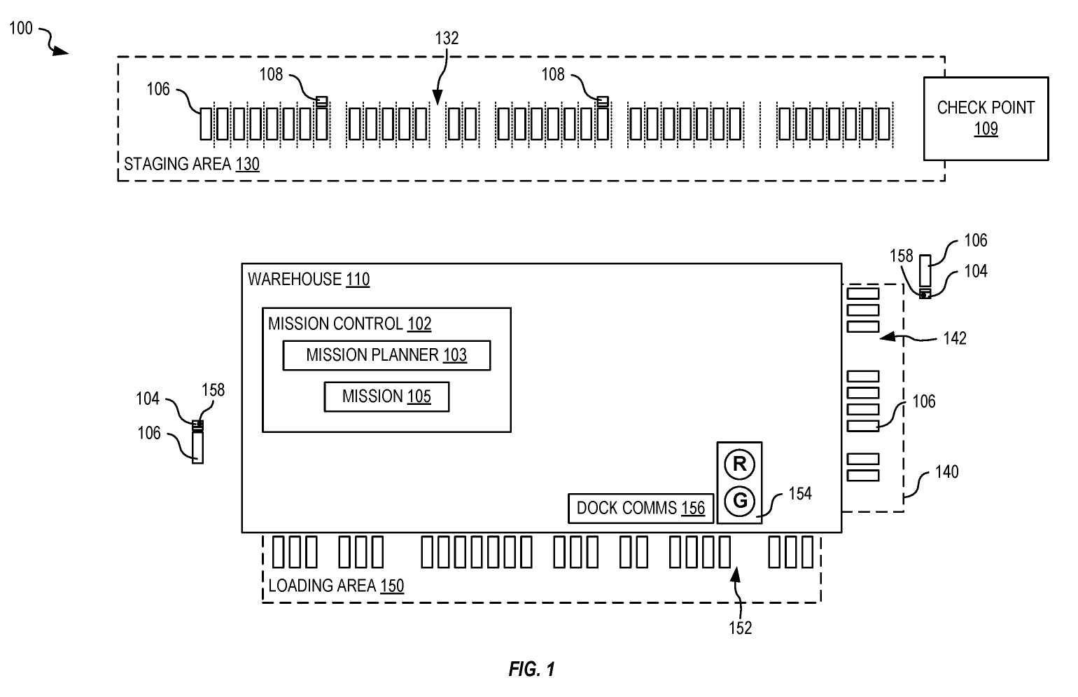

FIG. 1 is an aerial view showing one example autonomous yard 100 (e.g., a goods handling facility, shipping facility, etc.) that uses an autonomous tractor 104 to move trailers 106 between a staging area 130 and loading docks of a warehouse 110. The autonomous tractor 104 may be an electric vehicle, or may use a combustion-based engine such as a diesel tractor. For example, an over-the-road (OTR) tractors 108 deliver goods-laden trailers 106 from remote locations and retrieve trailers 106 for return to such locations (or elsewhere-such as a storage depot). In a standard operational procedure, OTR tractor 108 arrives with trailer 106 and checks-in at a facility entrance checkpoint 109. A guard/attendant enters information (e.g., trailer number or QR (ID) code scan-embedded information already in the system, which would typically include: trailer make/model/year/service connection location, etc.) into a mission control 102 (e.g., a computer software server that may be located offsite, in the cloud, fully onsite, or partially located within a facility building complex, shown as a warehouse 110). Warehouse 110 includes perimeter loading docks (located on one or more sides of the building as indicated by unloading area 140 and loading area 150), associated (typically elevated) cargo portals and doors, and floor storage, all arranged in a manner familiar to those of skill in shipping, logistics, and the like.

By way of a simplified operational example, after arrival of OTR tractor 108 and trailer 106, the guard/attendant at checkpoint 109 directs the driver to deliver trailer 106 to a specific numbered parking space in a designated staging area 130, which may include a large array of side-by-side trailer parking locations, hereinafter parking spots 132, arranged as appropriate for the facility's overall layout.

Once the driver has parked the trailer in the designated parking space of the staging area 130, he/she disconnects the service lines and ensures that connectors are in an accessible position (i.e. if adjustable/sealable), and decouples OTR tractor 108 from trailer 106. If trailer 106 is equipped with swing doors, this can also provide an opportunity for the driver to unlatch and clip trailer doors in the open position, if directed by yard personnel to do so.

At some later time, (e.g., when warehouse is ready to process the loaded trailer) mission control 102 directs (e.g., commands or otherwise controls) tractor 104 to automatically couple (e.g., hitch) with trailer 106 at a pick-up spot (e.g., parking spot 132) in staging area 130 and move trailer 106 to a drop-off spot at an assigned unloading spot 142 of an unloading dock in unloading area 140 for example. Accordingly, tractor 104 couples with trailer 106 at the pick-up spot, moves trailer 106 to unloading area 140, and then backs trailer 106 into the assigned loading spot 142 at the drop-off spot such that the rear of trailer 106 is positioned in close proximity with the portal and cargo doors of warehouse 110. The pick-up spot and drop-off spot may be any designated parking spot 132 in staging area 130, any unloading spot 142 in unloading area 140, and any loading spot 152 within loading area 150.

Manual and/or automated techniques are used to offload the cargo from trailer 106 and into warehouse 110. During unloading, tractor 104 may remain hitched to trailer 106 or may decouple (e.g., unhitch) to perform other tasks. After unloading, mission control 102 directs tractor 104 to move trailer 106 from a pick-up spot (e.g., unloading spot 142) in unloading area 140 and to a drop-off spot, either returning trailer 106 to parking spot 132 in staging area 130 or delivering trailer 106 to loading spot 152 of an assigned loading dock in loading area 150, where trailer 106 is then loaded. Once loaded, mission control 102 directs tractor 104 to move trailer 106 from a pick-up spot (e.g., loading spot 152) in loading area 150 to a drop-off spot (e.g., parking spot 132) in staging area 130 where it may await collection by another (or the same) OTR tractor 108. Given the pick-up spot and the drop-off spot, tractor 104 may autonomously move trailer 106.

Mission control 102 include a mission planner 103 (e.g., a software package) that generates a mission 105 (e.g., commands/requests/directives) that is sent to tractor 104 to cause tractor 104 to move trailer 106 from a pick-up spot to a drop-off spot, as described in further detail below. For example, mission control 102 may receive a request (e.g., via an API, and/or via a GUI used by a dispatch operator) to move trailer 106 from a first location (e.g., parking spot X in staging area 130) to a second location (e.g., unloading spot Y in unloading area 140). Once this request is validated, mission control 102 invokes mission planner 103 to generate mission 105 that is sent to tractor 104. For example, mission 105 is an ordered sequence of high level primitives to be followed by tractor 104, in order to move trailer 106 from location X to location Y. Mission 105 may include primitives such as drive along a first route, couple with trailer 106 in parking location X, drive along a second route, back trailer 106 into a loading dock, and decouple from trailer 106. Each loading dock (e.g., within unloading area 140 and loading area 150) may include a dock light 154 positioned at the loading dock that indicates a status of the loading dock. Dock light 154 changes (e.g., under control of an operator at the loading dock) between red and green to indicate when trailer 106 at the loading dock may (green), or may not (red), be moved, and when a trailer 106 may (green), or may not (red), be dropped at a loading dock without a trailer. Dock light 154 displays red to indicate that the loading dock should not be entered, usually because the trailer is being loaded or unloaded or because there is maintenance happening in that spot. Inadvertently moving an occupied trailer or entering a spot where maintenance is occurring endangers trailer occupants and/or maintenance personnel.

Each dock light 154 has a dock comms 156, implemented by a starcomms radio connected with dock light 154, that communicates with a truck comms 158, implemented by a starcomms radio located on tractor 104. Accordingly, tractor 104 uses truck comms 158 to wirelessly interrogate dock comms 156 at the loading dock it is intending to access to determine whether dock light 154 is displaying red or green.

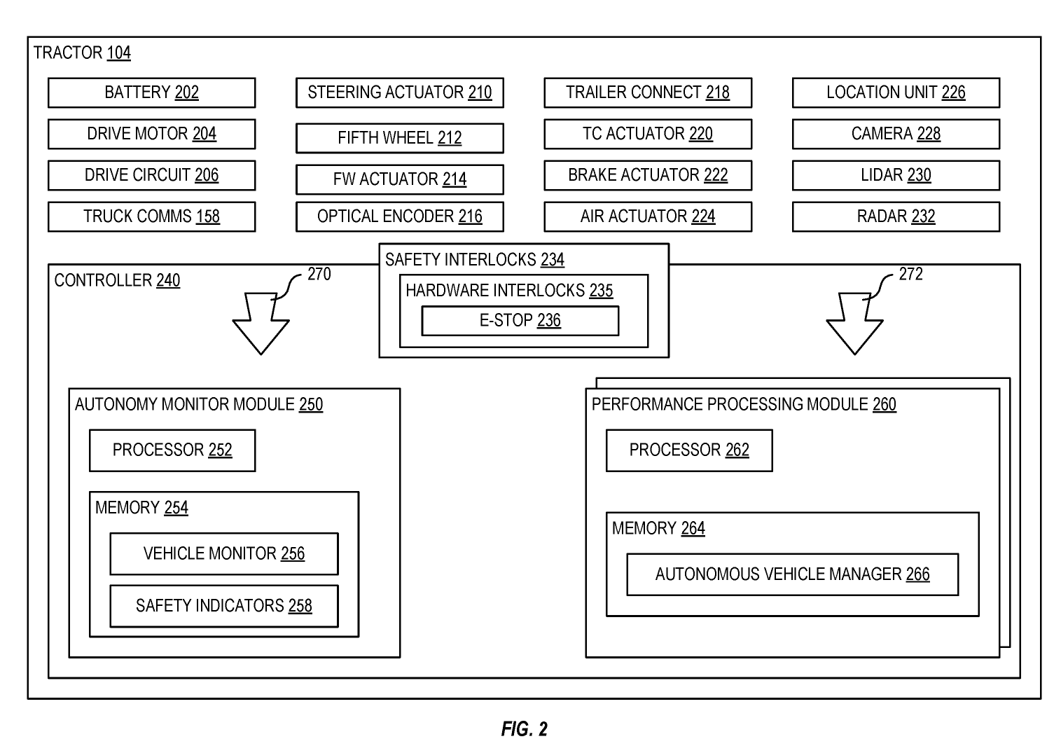

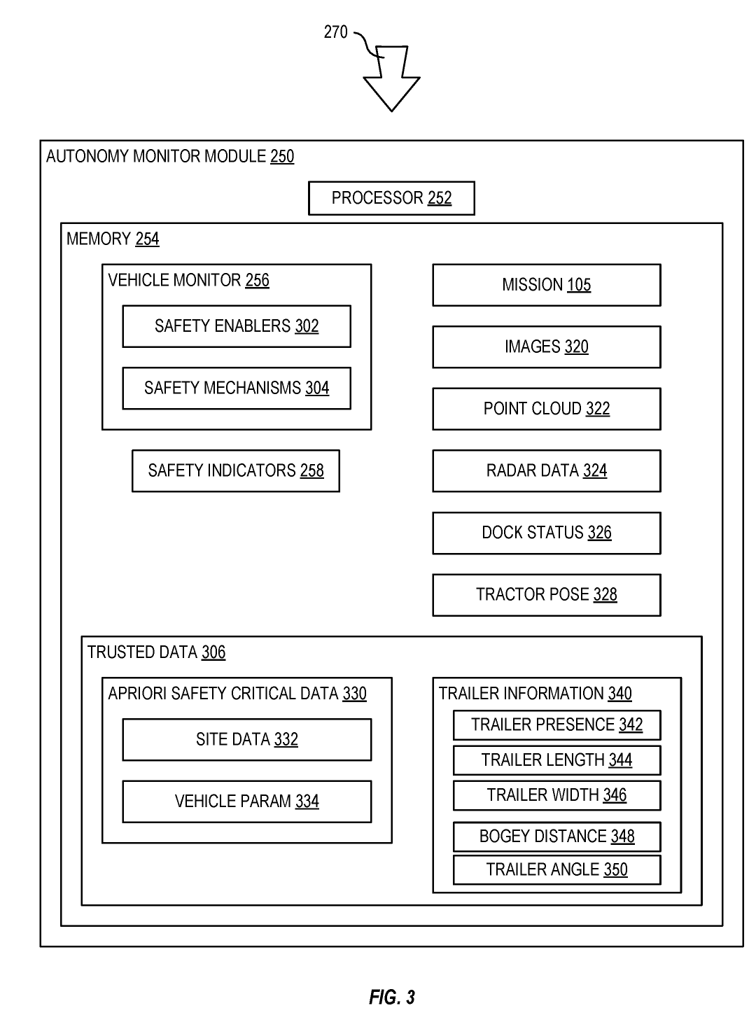

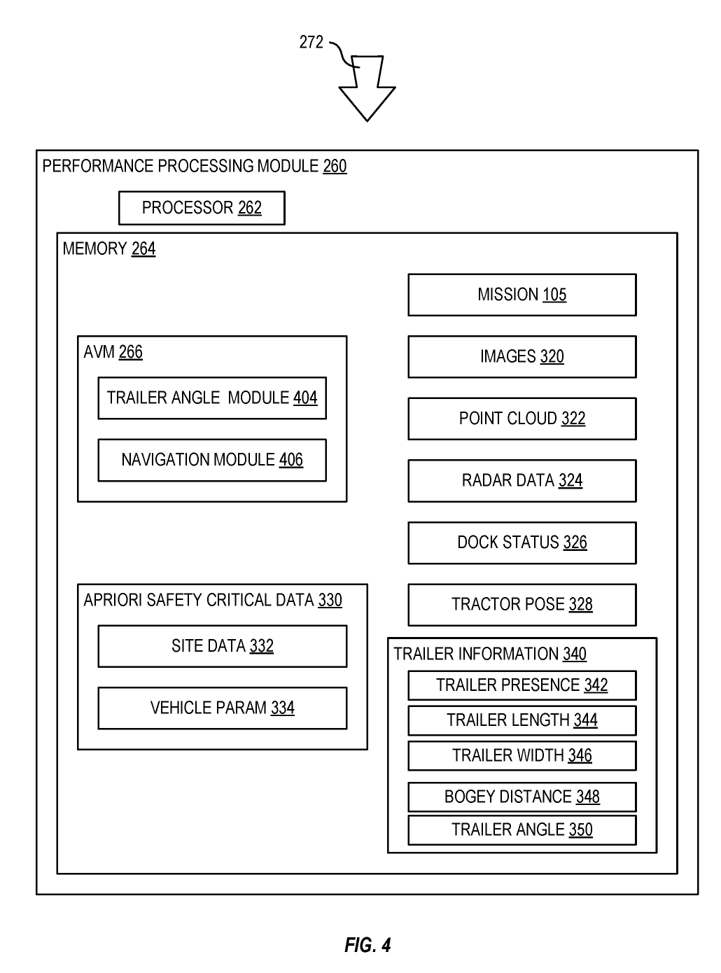

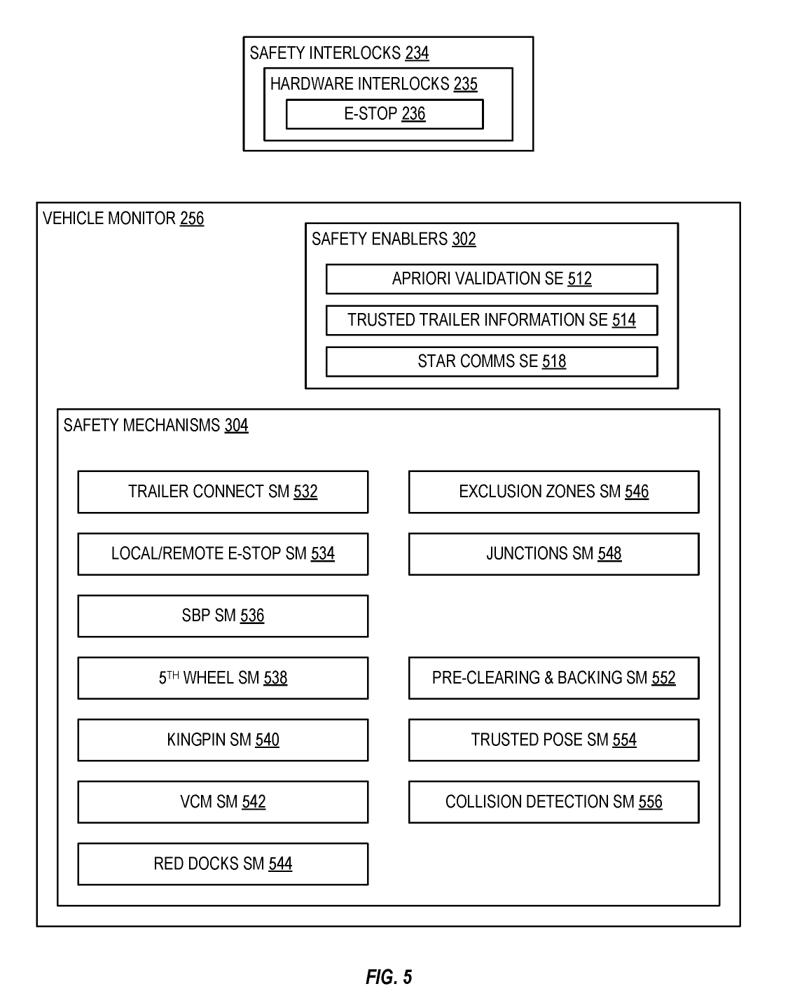

FIG. 2 is a block diagram illustrating example functional components of tractor 104, in embodiments. FIG. 3 is a schematic illustrating autonomy monitor module 250 of FIG. 2 in further example detail, in embodiments. FIG. 4 is a schematic illustrating one performance processing module 260 of FIG. 2 in further example detail, in embodiments. FIG. 5 is a schematic illustrating vehicle monitor 256 of FIG. 2 in further example detail, in embodiments. FIGS. 2, 3, 4, and 5 are best viewed together with the following description.

Tractor 104 includes a battery 202 for powering components of tractor 104, a drive motor 204 controlled by a drive circuit 206 to mechanically drive a plurality of wheels (not shown) and a steering actuator 210, to maneuver tractor 104. Tractor 104 also includes a fifth-wheel 212 (FW 212) for coupling with trailer 106 and a FW actuator 214 controlled by controller 240 to position FW 212 at a desired height, a trailer connect 218 (TC 218) and a TC actuator 220 controlled by controller 240 to operate TC 218 to autonomously couple an airline of tractor 104 with a gladhand of trailer 106. TC 218 is for example a robotic arm.

Tractor 104 also includes a brake actuator 222 and an air actuator 224 that are controlled by controller 240 to apply and release brakes of tractor 104 and trailer 106. FW 212 includes an optical encoder 216 for detecting changes in an angle of trailer 106 with respect to tractor 104. Tractor 104 also includes a location unit 226 (e.g., a GPS receiver) for determining a current location and pose of tractor 104, at least one camera 228 for capturing images of objects around tractor 104, at least one Light Detection and Ranging (LIDAR) device 230 (hereinafter LIDAR 230) for determining a point cloud about tractor 104, and at least one radar 232 for determining radar data about tractor 104. Tractor 104 also includes a truck comms 158 that implements wireless communication (e.g., LoRa) between a controller 240 of tractor 104 and other components of autonomous yard 100.

Controller 240 is implemented by multiple compute components including an autonomy monitor module 250 and at least two performance processing modules 260. Autonomy monitor module 250 is a high integrity compute device that operates substantially independently of performance processing modules 260 to monitor safety of operation of tractor 104. Autonomy monitor module 250 includes at least one processor 252 communicatively coupled with memory 254 that may include one or both of volatile memory (e.g., RAM, SRAM, etc.) and non-volatile memory (e.g., PROM, FLASH, Magnetic, Optical, etc.). Memory 254 stores a vehicle monitor 256 (VM 256) implemented as machine-readable instructions that, when executed by the at least one processor 252, cause the at least one processor 252 to implement safety monitors and mechanisms of tractor 104. Vehicle monitor 256 implements safety enablers 302 and safety mechanisms 304 to meet safety requirements (e.g., derived from ISO 26262 Functional Safety standard) for operation of tractor 104 within autonomous yard 100. Vehicle monitor 256 may generate and track safety indicators 258 to provide an indication of how often (e.g., frequency of) safety violations occur with tractor 104.

Performance processing module 260 includes at least one digital processor 262 communicatively coupled with memory 264 that may include one or both of volatile memory (e.g., RAM, SRAM, etc.) and non-volatile memory (e.g., PROM, FLASH, Magnetic, Optical, etc.). Memory 264 stores autonomous vehicle manager 266 (AVM 266) implemented as machine-readable instructions that, when executed by the at least one processor 262, cause the at least one processor 262 to control functionality of tractor 104 as described herein to operate autonomously within autonomous yard 100 under direction from mission control 102.

Location unit 226 determines an absolute location (e.g., geographic location) and orientation of tractor 104. Location unit 226, cameras 228, and LIDAR 230 may be controlled by controller 240 to enable autonomous maneuverability and safety of tractor 104.

In certain embodiments, FW actuator 214 includes an electric motor coupled with a hydraulic pump that drives a hydraulic piston that moves FW 212. However, FW actuator 214 may include other devices for positioning FW 212 without departing from the scope hereof. Controller 240 controls air actuator 224 to supply air to trailer 106 and controls brake actuator 222 to apply brakes of tractor 104 and trailer 106 when connected thereto via air actuator 224.

Tractor 104 also include safety interlocks 234 that implement both hardware and software locks on certain autonomous functionality of tractor 104. The interlocks are set to allow or prevent operation of certain actuators and thereby prevent autonomous control of the associated functionality of tractor 104. Accordingly, safety interlocks 234 enable or disable functionality of each of drive circuit 206, steering actuator 210, FW actuator 214, TC actuator 220 brake actuator 222, and air actuator 224, for example. Safety interlocks 234 are implemented at least in part by hardware (e.g., shown as hardware interlocks 235) that may be activated by software. For example, hardware interlocks 235 represents switching hardware that controls operation of certain components of tractor 104 that may be selected to have a safe condition when unpowered (e.g., a switch that is normally-open when unpowered, a valve that is closed when unpowered) and the associated software that controls the components is only activated when all safety conditions of the component are met. Further, the associated software that controls the components is deactivated when any of the safety conditions are violated. For example, safety interlocks 234 implement an emergency stop (E-STOP) 236, which is a function that places tractor 104 into a safe state when triggered, as described in further detail below.

Operational data from sensors (e.g., optical encoder 216, location unit 226, cameras 228, LIDAR 230, and radar 232), and output from truck comms 158 are input into pipelines 270 and 272 that flow to autonomy monitor module 250 and performance processing module 260, respectively. A critical subset of data in each pipeline 270 and 272 is identical; however, pipeline 270 may include data that is not included in pipeline 272 but is needed by autonomy monitor module 250, and pipeline 272 may include data that is not included in pipeline 270 but is needed by performance processing module 260. Autonomy monitor module 250 processes pipeline 270 to monitor operation of tractor 104 and to prevent tractor 104 from operating unsafely, and performance processing module 260 processes pipeline 272 and controls operation of tractor 104.

### Autonomy Monitor

Vehicle monitor 256 includes safety enablers 302 and safety mechanisms 304 that process operational data of tractor 104. Apriori safety critical data 330 may include site data 332 and vehicle parameters 334. As shown in FIG. 5, safety enablers 302 include an apriori validation SE 512, a trusted trailer information SE 514, and a starcomms SE 518. Apriori validation SE 512 monitors apriori safety critical data 330, such as to ensure that site data 332 and vehicle parameters 334 are trusted. At least part of trailer information 340 is monitored by trusted trailer information SE 514, such as one or more of, trailer presence 342, trailer length 344, trailer width 346, bogey distance 348, trailer angle 350, and so on. Starcomms SE 518 monitors dock status 326 to ensure that communications are operational (e.g., received at required intervals from dock comms 156). Safety mechanisms 304 include a TC SM 532, a local/remote E-STOP SM 534, a steering braking and propulsion (SBP) SM 536, a 5th wheel SM 538, a kingpin SM 540, a vehicle control management SM 542 (VCM SM 542), a red docks SM 544, an exclusion zones SM 546, a junctions SM 548, a pre-clearing and backing SM 552, a trusted pose SM 554, and a collision detection SM 556.

### Safety Enablers

Apriori safety critical data 330 includes data used by one or more safety mechanisms 304, such as exclusion zones SM 546, SBP SM 536 and Red docks SM 544. When apriori safety critical data 330 is incorrect and/or corrupted, use of apriori safety critical data 330 impacts monitoring and mitigation of hazards to tractor 104 operating within autonomous yard 100.

Autonomy monitor module 250 receives apriori safety critical data 330 from the cloud during initialization of controller 240. Apriori safety critical data 330 includes site data 332 defining layout of autonomous yard 100 and vehicle parameters 334 defining parameters of tractor 104. Particularly, site data 332 defines critical, and non-changing, parameters that define operational areas for tractor 104 within autonomous yard 100, and that define structure (e.g., non-moving objects such as building, walls, gateways, etc.) within autonomous yard 100. Vehicle parameters 334 define calibration of one or more of drive circuit 206, steering actuator 210, FW actuator 214, optical encoder 216, TC actuator 220, brake actuator 222, air actuator 224, position and view of each of cameras 228, LIDAR 230, and radar 232, and a size of tractor 104, that facilitate understanding of captured data to control tractor 104. Apriori safety critical data 330 is required and critical to operation of tractor 104 within autonomous yard 100.

In certain embodiments, site data 332 and vehicle parameters 334 are stored in binary and/or human readable files, such as “OREC” and “yaml” files, that contain information about autonomous yard 100 (e.g., mapping data, exclusion zones, parking spots, loading docks, structures, etc.), tractor 104 (e.g., Truck ID, and maximum allowed speed, etc.) and calibration parameters for cameras 228, LIDAR 230, and radar 232 of tractor 104. Accordingly, these binary and/or human readable files contain safety critical data used by controller 240 to control tractor 104 within autonomous yard 100. For example, these files may define a location and orientation of cameras 228, LIDAR 230, and radar 232 on tractor 104 and thereby provide parameters that allow corresponding images 320, point cloud 322, and radar data 324 to be used for detecting objects around tractor 104. Site data 332 contains information about autonomous yard 100, including a site ID, high resolution map data, and A Priori site map data such as exclusion zones, dock UUIDs, parking and dock spots, etc. Accordingly, vehicle monitor 256 invokes apriori validation SE 512 to evaluate apriori safety critical data 330 to ensure the data is received correctly, is the required data, and is trusted. In certain embodiments, apriori safety critical data 330 received by tractor 104 includes a manifest file that lists files of apriori safety critical data 330, and which of these files are to be checked by apriori validation SE 512.

Example files include: site_apriori.vm.orec, which is a binary file containing Site Apriori data (e.g., consumed by vehicle monitor 256); vehicle.cs.orec, which is a binary file containing a checksum of a 'vehicle.yaml' file that is downloaded from the cloud and used to perform perception based safety system (PBSS) Apriori Validation; vehicle.vm.orec, which is a binary file containing the Vehicle Apriori data that is consumed by vehicle monitor 256; and vehicle.yaml, which is a human readable file containing calibration data for sensors (e.g., optical encoder 216, plurality of cameras 228, LIDAR 230, and radar 232) of tractor 104.

Vehicle monitor 256 invokes apriori validation SE 512 to validate apriori safety critical data 330 before apriori safety critical data 330 may be used by performance processing module 260. Apriori safety critical data 330 is shown within trusted data 306 of autonomy monitor module 250, and is made available to other processing modules (e.g., performance processing module 260) of controller 240. In one example of validation, apriori validation SE 512 compares a current location (e.g., determined by location unit 226) of tractor 104 against apriori safety critical data 330 to determine that apriori safety critical data 330 applies to the current location. Where apriori safety critical data 330 does not match the current location, apriori validation SE 512 determines that apriori safety critical data 330 is invalid. In another example, vehicle monitor 256 compares a predefined checksum of apriori safety critical data 330 to a local checksum calculated within controller 240. Where the local checksum does not match the predefined checksum, apriori validation SE 512 determines that apriori safety critical data 330 is invalid. In another example, each binary and human readable file includes a digital signature of an entity that generated the file, whereby apriori validation SE 512 determines the file is invalid when the digital signature cannot be authenticated. When apriori validation SE 512 indicates that apriori safety critical data 330 is invalid, vehicle monitor 256 invokes E-STOP 236 causing tractor 104 to enter a safe state. When apriori validation SE 512 indicates apriori safety critical data 330 is valid, operation of tractor 104 continues. These checks may be performed periodically or at intervals.

Trusted trailer information SE 514 validates trailer information 340, which defines a status of trailer 106 when hitched to tractor 104. Trailer information 340 includes a trailer presence 342, a trailer length 344, a trailer width 346, a bogey distance 348, and a trailer angle 350. Trailer information 340 is trusted to estimate a trailer pose, where mis-estimation of the trailer pose may lead to collision of trailer 106 with objects such as adjacent trailers, and/or pedestrians. Bogey distance 348 is a position of the rear axle of trailer 106, which is changeable.

Trailer presence 342 is evaluated against multiple sources to confirm the presence of trailer 106 hitched to tractor 104. Trust of trailer angle 350 is also determined using multiple sources (e.g., optical encoder 216 and point cloud 322 generated by LIDAR 230). This may be referred to as multi-sensor fusion. When trusted trailer information SE 514 discovers a significant error between the multiple sources of trailer information 340, trailer information 340 is not trusted and trusted trailer information SE 514 initiates E-STOP 236. Trailer information 340 is shown within trusted data 306 and is available to other modules (e.g., performance processing module 260) of controller 240.

Trusted trailer information SE 514 monitors trailer angle 350 during maneuvering of trailer 106 by tractor 104, and when trusted trailer information SE 514 detects a significant error in trailer angle 350 (e.g., an error large enough that a distance between the estimated back corner of any trailer in the operational design domain (ODD) and the actual location of the back corner of the trailer given the trailer angle error) is larger than the smallest object tractor 104 may detect in the ODD, then trusted trailer information SE 514 triggers E-STOP 236.

Trusted trailer information SE 514 evaluates trailer length 344 against multiple sources to determine when trailer length 344 is trusted. When an error between a trailer length derived from the multiple sources is significant, trusted trailer information SE 514 invokes E-STOP 236.

Star comms SE 518 provides a dock status 326 within controller 240 of tractor 104 with a high integrity indication of the dock lights (RED/GREEN).

When provided data for dock light 154 is corrupt, stale (e.g., not current), or otherwise unknown, star comms SE 518 sets dock status 326 as 'RED'. Start comms SE 518 is an enabler for red docks SM 544, such that when tractor 104 attempts to enter a loading dock whose status is not confirmed 'GREEN' by star comms SE 518, red docks SM 544 triggers E-STOP 236. Star comms SE 518 monitors signals received from dock light 154 via dock comms 156 and/or star comms 120, and when the signal is not received or is unknown/corrupted (e.g., when communication integrity cannot be verified), then star comms SE 518 or red docks SM 544 triggers E-STOP 236.

Autonomy monitor module 250 receives mission 105 from mission control 102, images 320 captured by cameras 228, point cloud 322 captured by LIDARs 230, radar data 324 captured by radars 232, dock status 326 received from dock comms 156 via truck comms 158, and apriori safety critical data 330. Autonomy monitor module 250 continues monitoring operation of tractor 104 and trailer 106 when hitched thereto, during autonomous control.

### Autonomy Processing

AVM 266 is software that controls autonomous operation of tractor 104 and includes the ability to provide manual control (when selected through the appropriate human actions) and computer control (again, when selected). In manual control, all actuations are controllable by a driver of tractor 104. In computer control, all actuations are controllable by controller 240 unless disabled or brought to the safe state as controlled by safety interlocks 234.

As shown in FIG. 4, AVM 266 includes a trailer angle module 404 and a navigation module 406 that cooperate to process images 320, point cloud 322, radar data 324, dock status 326, apriori safety critical data 330 and trailer information 340 to control autonomous operation of tractor 104 to complete mission 105. AVM 266 may include additional modules without departing from the scope hereof.

When tractor 104 is operating with computer control, AVM 266 controls operation of tractor 104 based upon mission 105 received from mission control 102. Trailer angle module 404 determines a trailer angle 350 between tractor 104 and trailer 106 based on one or more of data from optical encoder 216 positioned near FW 212 and mechanically coupled with a Kingpin of trailer 106, images 320 captured by cameras 228, a point cloud 322 captured by LIDAR 230, and radar data 324 captured by radar 232. This may be referred to as multi-sensor fusion. AVM 266 processes images 320, point cloud 322, radar data 324, tractor pose 328, and trailer information 340 and generates commands for one or more of drive circuit 206, steering actuator 210, FW actuator 214, TC actuator 220 brake actuator 222, and air actuator 224 to control movement of tractor 104 and trailer 106 when hitched thereto.

Navigation module 406 uses location unit 226 to determine a tractor pose 328 that defines a current location and orientation of tractor 104. Navigation module 406 may also use other sensors (e.g., camera 228 and/or LIDAR 230) to determine tractor pose 328 using features of the environment for example.

### Safe State Strategy

A safe state of tractor 104 is when it is fully stopped; when tractor 104 is not moving, when FW 212 is stationary, and when TC 218 is stationary.

### Warning Strategy

Remote support personnel may be notified, via Wi-Fi and/or cellular communication, when safety mechanisms 304 indicate a safety critical situation such that operation of tractor 104 is inhibited. For example, where apriori validation SE 512 determines that apriori safety critical data 330 is invalid, vehicle monitor 256 may notify remote support personnel to aid in resolution and initiate a root cause investigation. Relevant data may be logged for detailed investigation. Vehicle monitor 256 may also maintain safety performance indicators that track the occurrence rate of each fault on tractor 104.

### Recovery Strategy

When vehicle monitor 256 detects apriori safety critical data 330 is invalid, vehicle monitor 256 requests new apriori safety critical data 330 from the cloud. The newly received apriori safety critical data 330 is validated, and when the validation is successful, tractor 104 is released from the safe state and normal operation is allowed. When the validation fails continuously for more than three attempts then manual intervention is required and new site data 332 and/or vehicle parameters 334 should be uploaded to the cloud. When vehicle monitor 256 cannot validate apriori safety critical data 330, tractor 104 cannot operate autonomously, however, tractor 104 may be operated manually (e.g., to be brought in for maintenance).

### Monitoring Strategy

Once apriori safety critical data 330 is stored and validated, vehicle monitor 256 monitors the stored apriori safety critical data 330 for any corruption due to memory issues. When data corruption is detected (e.g., by evaluating a check sum of the data), vehicle monitor 256 initiates E-STOP 236 to bring tractor 104 to a safe state.

Similarly, once apriori safety critical data 330 is validated and stored, vehicle monitor 256 monitors the stored apriori safety critical data 330 for any corruption due to memory issues, such as by checking a checksum of apriori safety critical data 330 at intervals. When data corruption is detected (e.g., when the checksum is incorrect), vehicle monitor 256 initiates E-STOP 236 to bring tractor 104 to a safe state.

### Safety Mechanisms

Each of the following safety mechanisms may implement any of the above described safe state strategy, warning strategy, recovery strategy, and monitoring strategy, as applicable.

TC SM 532 prevents hazards due to unintended movement of TC 218, particularly to prevent contact of the robotic arm with personnel in its vicinity. Of particular concern is the possibility that tractor 104 might drive around with TC 218 unstowed and sticking out, causing the robotic arm to contact a pedestrian or other object in autonomous yard 100. Trailer connect SM 532 causes safety interlocks 234 to inhibit movement of TC 218 whenever tractor 104 is moving. When SM 532 determines that TC 218 is not stowed and tractor 104 is moving, SM 532 triggers E-STOP 236. In one example of operation, TC SM 532 disables TC actuator 220 and applies brakes of TC 218, and TC SM 532 is only released when a speed of tractor 104 (measured with integrity by SBP SM 536) is zero and/or negligibly small. Hardware interlocks 235 includes a switch that sends power to the enable lines of a controller of TC 218. The switch defaults to an open state when not powered, thereby preventing an enable signal from going to the Robot Controller. Without the enable signal, neither TC 218 nor the rail on which the robotic arm is mounted are operable.

When TC interlocks of safety interlocks 234 are activated, control of TC actuator 220 is disabled to prevent autonomous operation of TC 218 and brakes of TC 218 are applied. TC interlocks are released only when a speed (measured with integrity by SBP SM 536) of tractor 104 is zero (e.g., negligibly small). TC interlocks may be implemented via a switch that when activated sends power to the enable lines of TC actuator 220, where the switch defaults to the open state when not powered. The switch thereby prevents an enable signal from going to TC actuator 220 when the TC interlocks are activated and neither the arm nor a rail on which it is mounted are operable. TC 218 may be configured with two switches that detect whether or not TC 218 is stowed, and the output of these switches is used by SM 532 and/or safety interlocks 234.

Local/remote E-STOP SM 534 provides two separate means for personnel at autonomous yard 100 to E-stop tractor 104: either a remote E-STOP, and a local E-STOP. The remote E-STOP is primarily for use in driverless testing and demos, as an extra precaution to avoid harm to people or any collisions. The local E-STOP may be used by personnel at autonomous yard 100 to ensure that tractor 104 is in a safe state before interacting with tractor 104. Local/remote E-STOP SM 534 triggers E-STOP 236 whenever a remote E-STOP, a local E-STOP, or a door switch E-STOP is activated.

Local E-STOP buttons are mounted inside a cab of tractor 104, and are mounted outside (e.g., at each side) of tractor 104. Safety rated door switches are also integrated into the doors of tractor 104. These switches are wired to safety interlocks 234, which initiates E-STOP 236 when they are activated. The remote E-stop device is an off the shelf, high-integrity system that consists of the remote transmitter and a corresponding receiver that is integrated into tractor 104 and wired safety interlocks 234. The remote E-STOP is also triggered when the receiver on tractor 104 loses contact with the remote E-STOP device.

SBP SM 536 enforces a maximum speed limit (e.g., 5mph) of tractor 104. In order to prevent unexpected movement and potential collisions with people or objects, SBP SM 536 also monitors for unexpected acceleration, loss of deceleration (e.g., loss of braking), and movement of tractor 104 when it is supposed to be stationary. For example, SBP SM 536 triggers E-STOP 236 whenever any unsafe motion of tractor 104 is detected that may lead to instability or a hazard, such as exceeding the maximum allowed speed, or movement when the AV is commanded to be stationary. SBP SM 536 monitors output from multiple different sensors, including location unit 226, odometry from wheels, data from steering actuator 210 and drive motor 204, and vehicle data from a CAN bus of tractor 104. SBP SM 536 processes this data to construct "trusted" information about vehicle speed, direction, distance traveled, and acceleration/deceleration. When SBP SM 536 determines that any of the monitored parameters exceeds corresponding threshold values for too long, or when SBP SM 536 detects sensor disagreement or missing sensor data, SBP SM 536 triggers E-STOP 236.

5^{th} wheel SM 538 prevents unintended lowering of FW 212 while tractor 104 is moving, which could damage legs of a hitched trailer 106 and thereby cause trailer 106 to fall over when unhitched, potentially harming people who are nearby, particularly when the trailer is unhitched at a loading dock and the trailer falls into another trailer that is being loaded/unloaded. 5^{th} wheel SM 538 causes safety interlocks 234 to inhibit powered movement of FW 212 when tractor 104 is moving above a predefined maximum speed (e.g., 3kph) to mitigate risk of dynamic changes that could cause instability as also to prevent the trailer legs from scraping the ground. Safety interlocks 234 implements an FW interlock for FW actuator 214 that disables movement of FW 212. This FW interlock is released only when 5^{th} wheel SM 538 determines that motion of tractor 104 is below the predefined maximum speed (e.g., 3kph) as signaled by vehicle monitor 256. In certain embodiments, safety interlocks 234 receives a signal from vehicle monitor 256 when the speed of tractor 104 is below the predefined maximum speed. The FW interlock is implemented to prevent power from getting to FW actuator 214 (e.g., to solenoids that control the hydraulics of FW 212, where the valves that allow movement of FW 212 are powered via the solenoids).

In certain embodiments, trailer presence 342 and trailer leg height (not shown) are determined to be trusted based on validation against multiple sensing methodologies by safety enablers 302. 5^{th} wheel SM 538 triggers E-STOP 236 when trailer presence 342 is true and trusted, when trailer leg height above ground is below a minimum threshold, and when speed of tractor 104 is not zero/negligible. For example, hardware interlocks 235 include a switch that prevents power from reaching solenoids that control hydraulics of FW 212 - only when the solenoids are powered may necessary air valves open to allow movement of FW 212. Vehicle monitor 256 informs safety mechanisms 304 of the vehicle condition, and based on that 5^{th} wheel SM 538 controls safety interlocks 234 to output either a voltage or no voltage to the switch.

Kingpin SM 540 prevents the Kingpin of trailer 106 from unlatching (e.g., releasing) from FW 212 while tractor 104 is towing trailer 106. Should trailer 106 detach from tractor 104 while being towed, trailer 106 could harm people in the vicinity. Kingpin SM 540 inhibits a Kingpin latch of FW 212 from unlocking while tractor 104 is moving. Safety interlocks 234 include a Kingpin interlock that disables the Kingpin latch unlock actuation within FW actuator 214. Safety interlocks 234 releases the Kingpin interlock only when a trusted speed of tractor 104 is zero or negligibly low. The Kingpin latch is unlocked when a pneumatic valve is opened to apply high pressure air to a mechanism of the Kingpin latch causing it to unlock. The Kingpin interlock is implemented to control a circuit that powers a solenoid that opens the pneumatic valve, wherein the solenoid cannot operate when the Kingpin interlock is active.

VCM SM 542 provide safe human interaction with tractor 104, including high integrity mode switching between computer control and manual control modes of operation, and ensures interference-free manual operation of tractor 104. Changing between computer control and manual control modes of tractor 104 affects behavior of certain safety mechanisms 304 (e.g., certain safety mechanisms that are operative only during computer control), and therefore VCM SM 542 is foundational to these certain safety mechanisms 304.

VCM SM 542 provides a high integrity method to change between computer control and manual control modes, ensures that manual control mode is free from interference (e.g., free from interference by attempted autonomous control, including safety mechanisms), ensures a safe operational sequence for activating and de-activating the computer control mode, and ensures that safety mechanisms 304 that trigger interlocks may do so with the appropriate integrity when in computer control mode. VCM SM 542 may also trigger E-STOP 236 to stop movement of TC 218, FW 212, and tractor 104.

VCM SM 542 provides human inputs for: switching between computer control and manual control modes, and for activating and de-activating computer control within computer control mode. VCM SM 542 also handles a state machine behavior associated with these modes and states, ensures that, in computer control mode, interlock triggers for certain safety mechanisms 304 are honored, and that in manual control mode tractor 104 is drivable and incapable of enacting computer control.

Safety interlocks 234 includes four interlocks within the scope of VCM SM 542 that provide the foundational ways that safety mechanisms 304 act on tractor 104. These interlocks are: E-STOP 236 interlock, which ensures tractor 104 stops by controlling braking and disabling propulsion; 5th Wheel lockout interlock, which inhibits 5th wheel motion when activated; motion lockout interlock, which prevents motion of TC 218 and unlocking of the Kingpin latch; and computer control interlock, which prevents computer control of actuation functions.

Red docks SM 544 prevents tractor 104 from interacting with any loading dock 142/152 displaying a red dock light 154. Any interaction by tractor 104 (or trailer 106 hitched to tractor 104) with a loading dock displaying a red dock light could harm people performing maintenance in or near the loading dock. Accordingly, tractor 104 is prevented from attempting to hitch to trailer 106 positioned at a loading dock displaying a red dock light, and prevented from towing trailer 106 away from the loading dock when already hitched. Moving trailer 106 during loading/unloading of the trailer could harm people inside the trailer. Red docks SM 544 triggers E-STOP 236 whenever tractor 104 is in, or attempts to enter, a loading dock whose dock comms 156 does not provide a current status confirmed to be green. Red docks SM 544 monitors the status of the dock light of the loading dock via truck comms 158 and dock comms 156, where dock comms 156 transmits a current status of dock light 154 to truck comms 158 when requested by truck comms 158. Red docks SM 544 triggers E-STOP 236 when tractor 104 or trailer 106 enters the loading dock while dock light 154 is RED, when tractor 104 attempts to connect to trailer 106 when the dock light is red, and when tractor 104 attempts to pull trailer 106 away from a loading dock with a dock light that is red. In certain embodiments, red docks SM 544 may allow tractor 104 (and trailer 106 when hitched thereto) to partially enter (e.g., cut the corner of) an adjacent dock spot as it is pulling out. Thus, tractor 104 and/or trailer 106 may slightly encroach upon an adjacent loading dock spot as trailer 106 is pulled away from the loading dock without causing red docks SM 544 to trigger E-STOP 236.

Exclusion zones SM 546 prevents movement of tractor 104, and trailer 106 when hitched to tractor 104, within exclusion zones of autonomous yard 100. Exclusion zones are, for example, a boundary around autonomous yard 100 that tractor 104 should not cross, and zones within autonomous yard 100 that tractor 104 should not enter, since entering any of these exclusion zones may lead to a collision between tractor 104 and/or trailer 106 and other objects (e.g., stationary and moving objects) and pedestrians. Exclusion zones SM 546 continuously monitors a current location (e.g., tractor pose 328) of tractor 104 with respect to nearby exclusion zones and triggers E-STOP 236 when tractor 104 or trailer 106 enters any exclusion zone. The exclusions zones may be apriori data defined within apriori safety critical data 330 that is loaded into controller 240 at startup. Exclusion zones SM 546 monitors the status of tractor 104 and trailer 106 and their trajectory to detect when tractor 104 and/or trailer 106 will enter the exclusion zone (known from the map data) and triggers E-STOP 236 to prevent tractor 104 and/or trailer 106 from entering the zone and from exiting autonomous yard 100 and entering a public area or public road adjacent to autonomous yard 100 for example.

Junctions SM 548 prevents tractor 104, or tractor 104 and trailer 106, from colliding with objects where perception of tractor 104 is occluded. Junctions SM 548 addresses two key situations where tractor 104 is at risk of pulling out into cross-traffic with occluded perception: (a) exiting a parking spot 132 or loading dock 142/152 where adjacent trailers 106 occlude perception of tractor 104 down the apron, and (b) entering an intersection where infrastructure of autonomous yard 100 or trailers obscure cross traffic. Intersections and spot exiting are collectively termed “Junctions,” which are defined within site data 332.

Tractor 104 may also be expected to stop prior to moving into an intersection or prior to crossing a cross walk. Deviation from that expected behavior could surprise other drivers or pedestrians and cause an accident. Accordingly, junctions SM 548 enforces that tractor 104 stops prior to entering an intersection and stops prior to crossing a crosswalk. Junctions SM 548 sets speed limits at specific locations of autonomous yard 100 where tractor 104 is expected to stop or where tractor 104 is expected to move very slowly (e.g., due to an occlusion). For example, tractor 104 is expected to travel at a very slow speed as it reaches an intersection as defined within site data 332 (e.g., marked on the map), or when pulling out of a loading dock and a parking spot as defined within site data 332 (e.g., as marked on the map).

There is also a dynamic element to junctions SM 548. When perception is occluded, junctions SM 548 limits tractor 104 to a speed calculated to allow tractor 104 time to stop to avoid a collision with cross traffic approaching from the area masked by the occlusion. When tractor 104 exceeds the speed limit set by junctions SM 548, junctions SM 548 triggers E-STOP 236.

Pre-clearing and trailer backing SM 552 ensures that a designated parking spot 132 and/or loading dock 142/152, into which trailer 106 is to be dropped, is free of obstacles prior to tractor 104 backing trailer 106 into that spot. Pre-clearing and trailer backing SM 552 also ensures that trailer 106 only enters that spot (e.g., the pre-cleared space) during backing of the trailer. For example, tractor 104 reversing trailer 106 has the same problem as a human driver: blind spots where trailer 106 blocks a view of 228, LIDAR 230, and/or radar 232, into the spot. Accordingly, tractor 104 captures images 320, point clouds 322, and radar data 324 of the parking spot to ensure it is clear before attempting to reverse trailer 106 into that spot. Pre-clearing and trailer backing SM 552 triggers E-STOP 236 when tractor 104 and/or trailer 106 enters a non-cleared space (e.g., an occupied adjacent spot) while reversing trailer 106 into the parking spot. Pre-clearing and trailer backing SM 552 monitors the precleared dock/parking zone, the status (e.g., tractor pose 328) of tractor 104 and trailer 106, and its driving direction and triggers E-STOP 236 when tractor 104 or trailer 106 enters a non-cleared zone. For example, pre-clearing and trailer backing SM 552 also triggers E-STOP 236 when too much time has passed since the spot was cleared (e.g., prior to tractor 104 backing the trailer 106 into the spot). The triggered E-STOP requires the tractor to clear the spot again before backing trailer 106 into it. Pre-clearing and trailer backing SM 552 also voids the pre-cleared spot when a dynamic object is detected going behind trailer 106 at any time during the maneuver, again requiring the spot to be cleared again before tractor 104 may reverse trailer 106 into the spot.

Trusted Pose SM 554 determines whether tractor pose 328 (e.g., location and orientation of tractor 104) is trusted. High integrity knowledge of tractor pose 328 is necessary to enable operations of many of the other safety mechanisms 304 described herein, such as red docks SM 544 and exclusion zones SM 546. However, pre-clearing and trailer backing SM 552 also rely on the trusted pose. When tractor pose 328 is incorrect, tractor 104 and/or trailer 106 may enter excluded areas of autonomous yard 100, or even exit the yard, leading to a number of potential hazards and collisions. Trusted pose SM 554 triggers E-STOP 236 when accuracy of tractor pose 328 cannot be confirmed, either due to corrupted or missing sensor inputs, or because multiple sources of data defining the pose disagree with each other by too great an amount. Trusted pose SM 554 monitors the source data used to estimate the pose of tractor 104 and trailer 106, and when the data is corrupted or when the information sources do not match statistically, then trusted pose SM 554 triggers E-STOP 236.

Collision detection SM 556 detects a collision between tractor 104 and/or trailer 106 hitched to tractor 104, and prevents tractor 104 from moving after the collision has occurred. Some collisions are unavoidable (e.g., when due to actions of another party) and may occur when tractor 104 is moving or stationary. After a collision, further movement of the tractor or the trailer is undesirable, since it may cause further harm. Collision detection SM 556 triggers E-STOP 236 when the collision is detected, and may also trigger a latching soft-stop to provide remote maintenance personnel with video feeds for determining details of the collision before allowing tractor 104 to continue. For example, when a latching soft-stop occurs, collision detection SM 556 may send a notification to the remote support personnel of the collision via a wireless network. A latching soft stop is a way of stopping tractor 104 that may be cleared remotely. The latching soft stop differs from E-STOP 236 and is implemented as a normal stop of tractor 104 within AVM 266. Once called, the latching soft stop requires an overt action by a person to clear it. That is, the latched soft stop is not cleared based on sensor input or a timer. For example, where a collision is suspected, the latched soft stop is triggered such that tractor 104 remains stopped until remote support personnel have evaluated the situation, such as by checking video feeds. If the remote support personnel determine that tractor 104 was involved in a collision, tractor 104 would remain stopped until local personnel have determined that it is safe for 104 to move. If the remote support personnel determine that there is no collision (e.g., as when someone touches tractor 104 when walking past), the remote support personnel may clear the soft stop and allow tractor 104 to continue its mission. Collision detection triggers E-STOP for as long as something is detected as being in collision (e.g., still touching) with tractor 104 and E-STOP cannot be cleared remotely. However, if the collision is no longer detected, the E-STOP may be cleared but a soft stop is maintained and remote support personnel are requested to investigate before allowing tractor 104 to move again.

Although there may not be direct safety goals derived for failure to validate apriori safety critical data 330 (e.g., the binary and human readable files), clearly when wrong and/or corrupted data is received as apriori safety critical data 330, one or more safety mechanisms 304, such as SBP SM 536, red docks SM 544, and exclusion zones SM 546 that uses this data may fail. Accordingly, apriori safety critical data 330 defines data received by tractor 104 from the cloud as safety critical and usable only when trusted.

Site data 332 is stored in the cloud with reference to a site ID and certain vehicle data that is specific to one vehicle is stored in association with the allocated vehicle ID. Vehicle parameters 334 are stored in the cloud and shared with tractor 104 on request. For example, when tractor 104 is activated, vehicle monitor 256 sends a request (e.g., a string containing a vehicle ID of tractor 104) to the cloud, and in response, the appropriate apriori safety critical data 330 is deployed to tractor 104. Apriori safety critical data 330 is first validated by vehicle monitor 256 (e.g., by invoking apriori validation SE 512) and then made available to other safety mechanisms 304, such as SBP SM 536, Red docks SM 544, and exclusion zones SM 546.

Controller 240 implements a plurality of strategies to increase safety in operation of tractor 104. An avoidance strategy proactively prevents any breach of the safety goals. Tractor 104 does not initiate movement or honor actuation requests until apriori safety critical data 330 is received and validated by vehicle monitor 256. Further, systematic processes are used to create apriori safety critical data 330, such that any errors in the data are caught at an early stage. Advantageously, these safety measures significantly reduce the likelihood of a safety goal violation resulting from apriori safety critical data 330.

Detection and control strategy identify incorrect and/or corrupt data and take actions needed to bring tractor 104 to a safe state. As part of this strategy, vehicle monitor 256 checks validity and integrity of apriori safety critical data 330 at frequent intervals during operation of tractor 104. When apriori safety critical data 330 is found invalid, vehicle monitor 256 triggers E-STOP 236 to bring tractor 104 to a safe state.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### Combination of Features

Features described above as well as those claimed below may be combined in various ways without departing from the scope hereof. The following enumerated examples illustrate some possible, non-limiting combinations:

(A1) A system for implementing safety within an autonomous tractor operating in an autonomous yard, including: a controller including at least one processor and memory storing machine-readable instructions; a plurality of sensors including a camera, a LIDAR, a radar, and an optical encoder; a plurality of actuators including a trailer connect actuator, a fifth wheel actuator, a steering actuator, and a brake actuator; safety interlocks configured to default to a safe state when unpowered; wherein the machine-readable instructions, when executed by the processor, cause the processor to: (a) validate apriori safety critical data including site data and vehicle parameters by authenticating a digital signature and verifying a checksum of a manifest file; (b) process operational data from the sensors to generate trusted data; (c) validate trailer information including trailer presence, length, width, bogey distance, and angle using the camera, the LIDAR, the radar, and the optical encoder; (d) monitor dock light status via wireless communication and verify communication integrity; (e) enforce speed limits and stop conditions at junctions and crosswalks based on occlusion detection; (f) pre-clear a parking spot or loading dock using sensor data and prevent the tractor or trailer from entering a non-cleared space; (g) detect a safety violation based on the trusted data; and (h) initiate an emergency stop (E-STOP) to place the tractor in the safe state where actuators are disabled.

(A2) In embodiments of (Al), the safety interlocks comprise hardware interlocks that prevent power from reaching the actuators when safety conditions are violated.

(A3) In either of embodiments (Al) or (A2), the machine-readable instructions, when executed by the processor, cause the processor to generate safety indicators to track frequency of safety violations and stores the indicators in the memory for performance monitoring.

(A4) In any of embodiments (Al)– (A3), the machine-readable instructions, when executed by the processor, cause the processor to periodically validate a checksum of stored apriori safety critical data during operation and triggers the E-STOP when corruption is detected.

(A5) In any of embodiments (Al)– (A4), the machine-readable instructions, when executed by the processor, cause the processor to initiate a latching soft-stop after collision detection and transmits a notification to remote personnel via a wireless network.

(A6) In any of embodiments (Al)– (A5), the machine-readable instructions, when executed by the processor, cause the processor to inhibit movement of the trailer connect actuator when tractor speed exceeds a threshold and prevent lowering of the fifth wheel and unlocking of a Kingpin latch when the tractor speed exceeds the threshold.

(A7) In any of embodiments (Al)– (A6), the machine-readable instructions, when executed by the processor, cause the processor to validate trailer pose using multi-sensor fusion comprising optical encoder data, LIDAR point cloud, and radar data.

(A8) In any of embodiments (Al)– (A7), the machine-readable instructions, when executed by the processor, cause the processor to monitor signals from dock communication radios and triggers the E-STOP when the signals are stale or corrupted.

(A9) In any of embodiments (Al)– (A8), the machine-readable instructions, when executed by the processor, cause the processor to enforce dynamic speed limits at the junctions based on the occlusion detection and calculated stopping distance.

(A10) In any of embodiments (Al)– (A9), the machine-readable instructions, when executed by the processor, cause the processor to prevent the tractor from entering exclusion zones defined in the apriori safety critical data and trigger the E-STOP when a violation is detected.

(B1) A method for implementing safety within an autonomous tractor operating in an autonomous yard, comprising: (a) validating apriori safety critical data including site data and vehicle parameters by authenticating a digital signature and verifying a checksum of a manifest file; (b) processing operational data from a camera, a LIDAR, a radar, and an optical encoder to generate trusted data; (c) validating trailer information including trailer presence, length, width, bogey distance, and angle using the operational data; (d) monitoring dock light status via wireless communication and verifying communication integrity; (e) enforcing speed limits and stop conditions at junctions and crosswalks based on occlusion detection; (f) pre-clearing a parking spot or loading dock using sensor data and preventing the tractor or trailer from entering a non-cleared space; (g) detecting a safety violation based on the trusted data; and (h) initiating an emergency stop (E-STOP) to place the tractor in a safe state where actuators are disabled.

(B2) The embodiment of (Bl) further including generating safety indicators to track frequency of safety violations and storing the indicators in memory.

(B3) Either embodiment of (Bl) and (B2) further including periodically validating a checksum of stored apriori safety critical data during operation and triggering the E-STOP when corruption is detected.

(B4) Any of embodiments (Bl)–(B3) further including initiating a latching soft-stop after collision detection and transmitting a notification to remote personnel via a wireless network.

(B5) Any of embodiments (Bl)–(B4) further including inhibiting movement of a trailer connect actuator when tractor speed exceeds a threshold and preventing lowering of a fifth wheel and unlocking of a Kingpin latch when the tractor speed exceeds the threshold.

(B6) Any of embodiments (Bl)–(B5) further including validating trailer pose using multi-sensor fusion comprising optical encoder data, LIDAR point cloud, and radar data.

(B7) Any of embodiments (Bl)–(B6) further including monitoring signals from dock communication radios and triggering the E-STOP when the signals are stale or corrupted.

(B8) Any of embodiments (Bl)–(B7) further including enforcing dynamic speed limits at the junctions based on the occlusion detection and calculated stopping distance.

(B9) Any of embodiments (Bl)–(B8) further including preventing the tractor from entering exclusion zones defined in the apriori safety critical data and triggering the E-STOP when a violation is detected.

(B10) Any of embodiments (Bl)–(B9) further including voiding a previously cleared parking spot or loading dock when a dynamic object is detected behind the trailer during backing.

What is claimed is:

1. A method for implementing safety in an autonomous tractor operating within an autonomous yard, comprising:
receiving operational data from a plurality of sensors of the tractor;
validating apriori safety critical data comprising site data and vehicle parameters prior to autonomous operation;
generating trusted operational data by comparing the operational data from multiple sources to ensure integrity;
processing the trusted operational data through a plurality of safety mechanisms to detect a safety violation; and
initiating an emergency stop (E-STOP) to bring the tractor to a safe state when the safety violation is detected.

2. The method of claim 1, wherein validating the apriori safety critical data comprises authenticating a digital signature of data files of the apriori safety critical data.

3. The method of claim 1, wherein generating the trusted operational data comprises comparing trailer angle from an optical encoder and a LIDAR point cloud.

4. The method of claim 1, further comprising triggering the E-STOP when a trailer connect actuator is not stowed while the tractor is moving.

5. The method of claim 1, further comprising inhibiting movement of a fifth wheel actuator when speed of the tractor exceeds a predefined threshold.

6. The method of claim 1, further comprising preventing release of a Kingpin latch when the tractor is moving.

7. The method of claim 1, further comprising triggering the E-STOP when a dock light status is red during interaction with a loading dock.

8. The method of claim 1, further comprising triggering the E-STOP when the tractor enters an exclusion zone defined in the apriori safety critical data.

9. The method of claim 1, further comprising triggering the E-STOP when the tractor exceeds a dynamic speed limit at a junction or crosswalk.

10. The method of claim 1, further comprising triggering the E-STOP when the tractor or trailer enters a non-cleared space during a backing maneuver.

11. A system for implementing safety in an autonomous tractor operating within an autonomous yard, comprising:
a controller including:
an autonomy monitor module configured to validate apriori safety critical data and monitor operational data for safety violations;
a performance processing module configured to control autonomous movement of the tractor;
a plurality of sensors including a location unit, cameras, LIDAR, radar, and an optical encoder; and
safety interlocks configured to inhibit actuation of one or more components of the tractor;
wherein the autonomy monitor module triggers an E-STOP to place the tractor in a safe state when a safety violation is detected.

12. The system of claim 11, wherein the safety interlocks comprise hardware interlocks that default to the safe state when unpowered.

13. The system of claim 11, wherein the autonomy monitor module includes a trusted pose mechanism configured to compare pose estimates from multiple sources.

14. The system of claim 11, wherein the autonomy monitor module includes a collision detection mechanism configured to trigger the E-STOP upon detecting a collision.

15. The system of claim 11, wherein the controller is configured to switch between manual and autonomous modes with integrity checks to prevent interference.

16. The system of claim 11, wherein the autonomy monitor module validates trailer information including trailer length, width, and bogey distance.

17. The system of claim 11, wherein the autonomy monitor module triggers the E-STOP when a difference between two pose estimates exceeds a threshold.

18. The system of claim 11, wherein the autonomy monitor module monitors dock status via wireless communication with dock lights.

19. The system of claim 11, wherein the safety interlocks include an E-STOP interlock, a fifth wheel lockout, and a motion lockout.

20. The system of claim 11, wherein the autonomy monitor module maintains safety performance indicators tracking fault occurrence rates.
